(19) United States
(12) Patent Application Publication
(10) Pub. No.: US 2008/0049238 A1
(43) Pub. Date: Feb. 28, 2008

(54) METHOD AND SYSTEM FOR AUTOMATIC WINDOW CLASSIFICATION IN A DIGITAL REPROGRAPHIC SYSTEM

(75) Inventors: Ramesh Nagarajan, Pittsford, NY (US); Xing Li, Webster, NY (US); Peter D. McCandlish, Rochester, NY (US); Francis Kapo Tse, Rochester, NY (US)

Correspondence Address: BASCH & NICKERSON LLP, 1777 PENFIELD ROAD, PENFIELD, NY, 14526, US

(73) Assignee: Xerox Corporation, Stamford, CT (US)

(21) Appl. No.: 11/467,584

(22) Filed: Aug. 28, 2006

(51) Int. Cl. G06F 15/00

(52) U.S. Cl. 358/1.9

(57) ABSTRACT

A method and system for processing an image in a digital reprographic system that performs a first segmentation process upon a contone digital image to identify one of a plurality of image data types for each pixel in the contone digital image, generating tags, binarizing the contone digital image and storing the binary image as an intermediate format. This binary image is later reconstructed to generate a reconstructed contone digital image; and performing a second segmentation process upon the reconstructed contone digital image to identify areas of the reconstructed contone digital image with common image data types.

### BACKGROUND

Digital multifunction reprographic systems are well known and have replaced optical reprographic systems as a way to reproduce documents. In conventional digital multifunction reprographic systems, a scanner accepts a document to be copied and converts the document into electronic image(s). These images, usually in the form of pages, are then passed to a central control unit which may re-order or reorganize these pages and then, depending on the request of the user of the device, send the pages or images to a destination. Often this destination is an attached printing unit which makes one or more copies of the original document.

However, these conventional devices perform many other functions besides simple copying. The central control unit is usually equipped with a combination of hardware and software elements that enable central control unit to accept input from other sources. The other sources may include some sort of network interface and/or an interface to a telephone system to enable FAX input.

The network interface is usually configured so that it can accept jobs to be printed from any computer source that is connected to the network. This configuration normally includes elements that can convert input documents formatted in one or more page description languages (PDLs) to the native format of the printing device.

An important inner component of such a conventional multifunction digital device is the image path. The image path is a combination of software and hardware elements that accepts the electronic images from the multiplicity of sources and performs any operations needed to convert the images to the format desired for the various output paths. The image path is usually one of the more complex and costly components of such digital multifunction devices.

The image path for a conventional multifunction device usually has several constraints. On the one hand, there is a desire to make the image path utilize data in a multi-bit per pixel format so as to provide for maximum image quality and a minimum loss of critical information in the transformation of documents from paper to electronic form. On the other hand, there are cost constraints and perhaps performance limits on the devices or software that comprise the image path.

Conventional image path electronics may also utilize binary image paths. In this situation, if the input information is scanned in a binary manner at sufficiently high resolution, the scanned image can be reconstructed at the output with little or no perceptible loss of image quality.

One way to implement the resolution conversion is to pass the binary data through a digital equivalent of a two-dimensional low pass filter. The digital equivalent of a two-dimensional low pass filter may replace each pixel in the binary image by the average of the values within some window centered on the pixel of interest. While such a system does an adequate job of converting the high resolution binary data to analog data, these solutions also have the deleterious effect of smearing sharp edges in the original document. Such an effect is particularly detrimental when reproducing text and line art.

Another component of many conventional multifunction devices, especially for those devices having a printing engine that is capable of producing colored output, is the use of analog modulation schemes for the output. In these devices, analog data, in the form of multi-bit pixels, is presented to the modulator of the output printing device. One such modulator compares the analog equivalent of the input byte of data to a periodic saw tooth wave. The output therefrom is a signal to the laser imaging component that is pulsewidth modulated by the data stream.

As multifunction reprographic systems have become more common in the office environment, and especially as multifunction reprographic systems have become color capable, the need for higher image quality has become more acute. Indeed the quality demands of a common office multifunction reprographic system are now higher than the image quality of a high end system of only a few years ago.

Because different types of image content require different image processing and modulation to maximize the image quality, it is also desirable to be able to identify the various elements that compose the page to be printed and to perform differential image processing on the various elements based on their image content type. However many of the schemes that are used to identify the image content type of the elements on a page are either computationally expensive or else require expensive resources to implement them. This has not been a hindrance in high end reprographic systems where the cost and performance constraints can be resolved by using more expensive hardware elements.

There are a variety of ways of identifying image content. One example is an auto-windowing process, as described, for example, in U.S. Pat. No. 5,850,474 and U.S. Pat. No. 6,240,205. The entire contents of U.S. Pat. No. 5,850,474 and U.S. Pat. No. 6,240,205 are hereby incorporated by reference.

The auto-windowing process has proven useful and effective in a number of high end systems. However, auto-windowing requires extra processing and a large amount of buffer memory for its implementation.

Image data is often stored in the form of multiple scanlines, each scanline comprising multiple pixels. When processing this type of image data, it is helpful to know the type of image represented by the data. For instance, the image data could represent graphics, text, a halftone, contone, or some other recognized image type. A page of image data could be all one type, or some combination of image types.

It is known in the art to take a page of image data and to separate the image data into windows of similar image types. For instance, a page of image data may include a halftone picture with accompanying text describing the picture. In order to efficiently process the image data, it is known to separate the page of image data into two windows, a first window representing the halftone image, and a second window representing the text. Processing of the page of image data can then be efficiently carried out by tailoring the processing to the type of image data being processed.

It is also known to separate a page of image data into windows and to classify and process the image data within the windows by making either one or two passes through the page of image data. The one pass method is quicker, but it does not allow the use of “future” context to correct information that has already been generated. In a two pass method, information obtained for a third or fourth scanline can be used to generate or correct information on a first or second scanline. In other words, future context can be used.

In a two pass method, during the first pass, the image is separated into windows, and a judgment is made about the type of image data in each window. At the end of the first pass, the image type for each pixel is recorded in memory. During the second pass, the information from the first pass, i.e., the image type data is used to process the image data. Unfortunately, storing image type information for each pixel of a page of image data requires a great deal of memory, which increases the cost of an apparatus for performing this method.

Therefore, it is desirable to provide a system or methodology that implements auto-windowing where such a system meets the cost and performance constraints of an office environment machine.

### BRIEF DESCRIPTION OF THE DRAWINGS

The drawings are only for purposes of illustrating various embodiments and are not to be construed as limiting, wherein:

FIG. 1 shows a block diagram of an image path that uses two pass segmentation;

FIG. 2 shows a block diagram of an image path that uses two pass segmentation with binarization of the intermediate image;

FIG. 3 shows a different image path that uses two pass segmentation with binarization of the intermediate image;

FIG. 4 shows a flow diagram of the two pass segmentation process;

FIG. 5 shows a section of a page image with different image data types;

FIG. 6 shows how the different image data types are identified on a scan line of a page image;

FIG. 7 shows a graphical representation of a digital filtering process that eliminates edge artifacts;

FIG. 8 shows a block diagram of a system utilizing the process of FIG. 5 and incorporating a tonal reproduction curve module;

FIG. 9 illustrates an one-dimensional graphical representation of a digital filtering process that eliminates edge artifacts;

FIG. 10 shows a block diagram of a system utilizing a digital filtering process that eliminates edge artifacts;

FIG. 11 shows a block diagram of a system utilizing a digital filtering process that eliminates edge artifacts;

FIG. 12 shows a block diagram of a system utilizing a digital filtering process that eliminates edge artifacts;

FIG. 13 illustrates a method for generating a set of lookup tables for reconstructing a contone image from a binary image;

FIG. 14 illustrates a 4×4 pattern generation kernel matrix;

FIG. 15 shows how the 4×4 matrix from FIG. 4 is used to generate a unique pattern identifier; and

FIG. 16 shows a circuit that generates a reconstructed contone version of a tagged binary image.

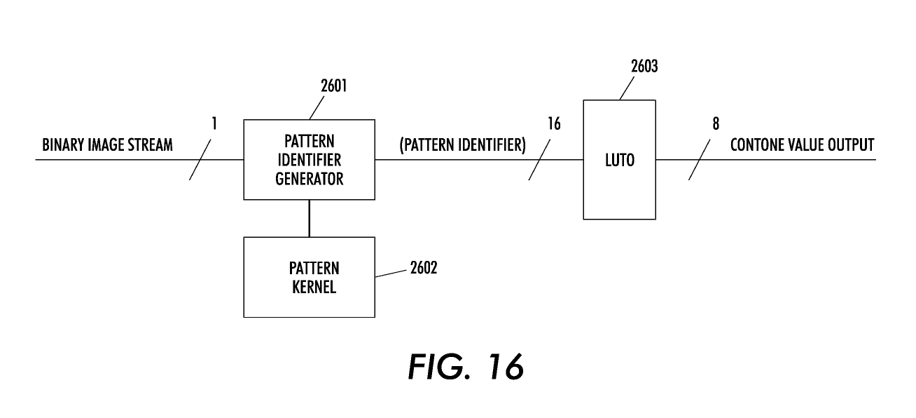

### DETAILED DESCRIPTION

For a general understanding, reference is made to the drawings. In the drawings, like references have been used throughout to designate identical or equivalent elements. It is also noted that the drawings may not have been drawn to scale and that certain regions may have been purposely drawn disproportionately so that the features and concepts could be properly illustrated.

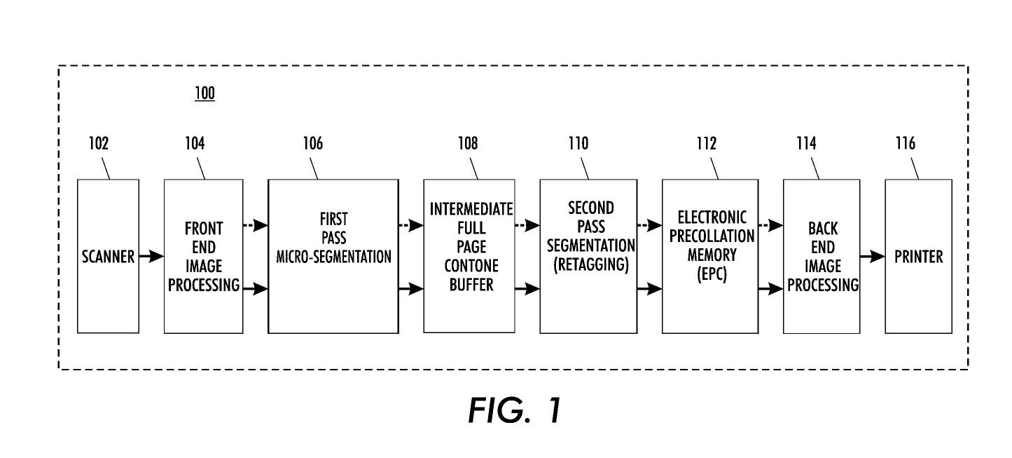

FIG. 1 illustrates the image path 100 for a system employing auto-windowing for image object type identification. A page scanner 102 scans individual pages of a document and passes a digital contone image to a front end processing 104 and then to a first pass segmentation module 106. The output of the first pass segmentation module is connected to an intermediate page image buffer 108. The output of the intermediate page buffer is connected to a second pass segmentation module 110. The output of the second pass segmentation module is then sent to an electronic precollation memory 112. The output of the electronic precollation memory is passed to the back end image processing module 114. Finally the output of the back end image processing module 114 is passed to the page printer 116 for printing.

In operation, the scanner 102 passes a contone image of the page being processed to the front end image processing 102. The front end image processing takes care of correcting the image from the scanner for various artifacts related to the scanner itself, for example non-uniformity of illumination of the scanner lamp. The corrected image is then processed by first segmentation module 106. The first segmentation pass processes the page image a scan line at a time, to identify various image data types from the characteristics of the adjacent pixel values on the scan line. This identification might include such image data types as text and line art, low frequency halftone images, high frequency halftone images, as well as others.

The output of the first pass segmentation is a tag image where the tag image encodes one of the image data types that the corresponding page image pixel is identified to be. It is noted that the tag image may be smaller than the page image, or the same size as the page image. Both the page image and the tag image are passed on to the following stages. FIG. 1 shows the page image as being passed from element to element by means of a solid arrow, while the tag image passage is indicated by the dashed arrows between elements.

Both the tag image and the page image are stored in an intermediate buffer memory for the second pass of auto-window tagging, This storage is necessary because the second pass must have the entire image available to it rather than processing the image a scan line at a time. This intermediate buffer storage can be quite large—for example if the page images are scanned at 600 dpi and 8 bits/pixel in color (RGB) the intermediate buffer memory could be over 400 MB if the reprographic device has to handle 11″×17″ pages. This memory represents a significant extra cost in the office reprographic environment and has been one of the barriers to the adoption of the two pass auto-windowing.

The second pass of the auto-windowing process takes place in module 110. Here the evaluation of the page is repeated, but wherever possible contiguous regions of the image are lumped together into windows, where all or most of the pixels in the region are identified as having a common image data type. When the second pass is complete, all pixels of the page image have been tagged, and for most pages, the page image tag has been divided into large windows of common image data types. This revised tagging replaces the original tag image from the first stage segmentation

After the auto-windowing segmentation is complete, the page image and its associated tag image are stored in an electronic precollation memory 112. This memory allows the reprographic system to modify the output of the document being processed in a number of ways not related to image processing but rather to the way the pages are ordered in the output tray. For example a document may be scanned once, but multiple copies generated without the need to rescan the document, or the page order may be reversed—that is the document is scanned from the first to last page, but is output last to first to accommodate the way the output is stacked. Other uses for the electronic precollation memory are well known and will not be further discussed here,

When the reprographic system is ready to print a page, the page image and its associated tag image are retrieved from the electronic precollation memory and passed through the back end image processing module 114. In this module, any image processing is performed that is needed to prepare the image for the specific requirements of the printer. Such functions might include any halftoning that is needed if the output printer can only accept binary image data. For color images, the back end image processing might include conversion of the input page format, commonly in RGB color space to the CMYK space needed by the printer. Such color conversion may also include the application of any image modification functions such as contrast enhancement. After the back end image processing, the image is sent to the printer 116.

The above image path has the capacity to generate high quality images, but has the disadvantages of a large intermediate buffer. A further barrier to using such an image path in the office is the fact that the image path is contone. This means that all elements of the image path as well as the connections between the elements of the image path must accommodate multiple bit images. This increases both the cost and processing requirements to process the page images.

To address these disadvantages, the image path is modified to convert a contone image into a higher resolution binary image and then reconstruct a contone image from the high resolution binary image only when it is needed. By modifying the image path with a contone to binary to selective contone conversion, as noted above, the barriers to wide spread adoption of a two pass segmentation scheme in an office reprographic system can be substantially eliminated.

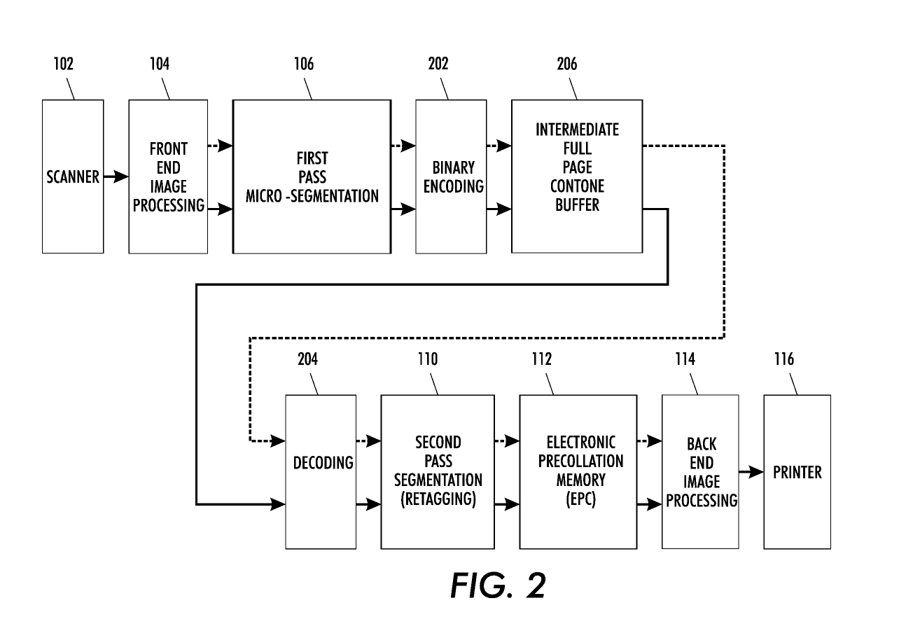

FIG. 2 illustrates a modified version of the image path of FIG. 1 where binary encoding and contone reconstruction have been included. The image path has been modified from the image path in FIG. 1 by the addition of two elements: a binarization module 202 connected between the first stage segmentation 106 and the intermediate image buffer 206, and a contone reconstruction module 204 connected between the output of the intermediate image buffer 206 and the second stage segmentation 110. Because of the binary encoding of the image, the intermediate buffer 108 has become a binary buffer 206.

Page images proceed through the first stage segmentation 104 as in FIG. 1. After the first stage segmentation however, the contone page image is converted to a high resolution binary image by the binarization module 202. The actual conversion of the contone page image to a high resolution binary image may be realized using one of the many conventional processes for converting a contone page image to a high resolution binary image. An example of a conventional conversion process is a halftoning process.

The resulting binary image is stored in an intermediate buffer 206 along with the first pass tag image. Since the image has been binarized, the amount of buffer memory required is much smaller. In addition, the tag image can be compressed, for example, using a lossless compression scheme.

When the second stage segmentation is ready to proceed, the binary page image is retrieved from the intermediate image buffer 206 and reconstructed into a contone image in decoding module 204. The tag image is also reconstructed by uncompressing it if it was compressed. The reconstructed page image and the tag image are then processed by the second stage segmentation circuit 110.

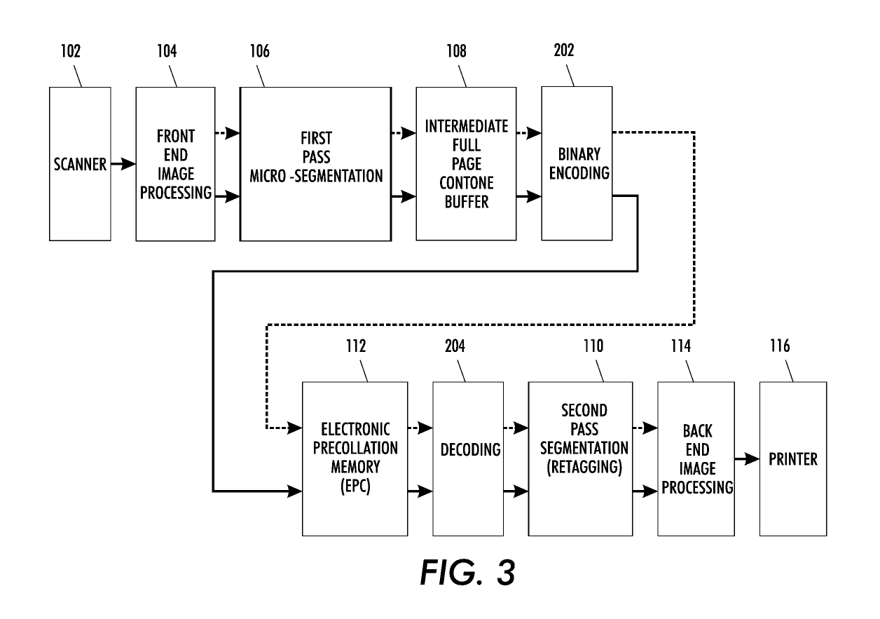

FIG. 3 shows a further modification to the image path of FIG. 2. In this modification, the image reconstruction 204 and second stage segmentation 110 have been moved to after the electronic precollation memory 112. This modification reduces the storage demands on the electronic precollation memory 112 since the data being stored is in binary form. In addition, the image path between the output of the binarization stage 202 and the second segmentation stage 108 is binary, further reducing the performance and cost demands on the device.

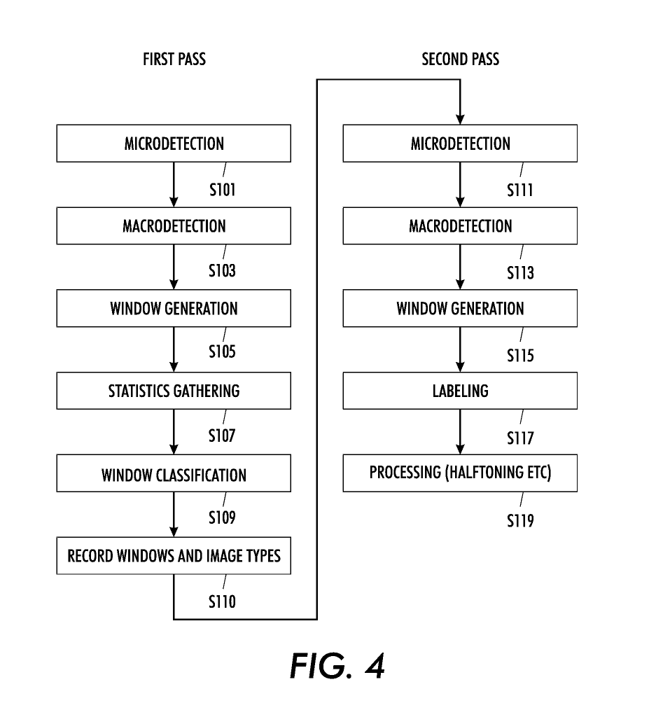

An exemplary auto-windowing process is illustrated in FIG. 4. In this process, during the first pass through the image data, micro-detection and macro-detection are performed to separate each scanline of data into edge sections and image run sections. During micro-detection, the image type of each pixel is determined by examining neighboring pixels. During macro-detection, the image type of image runs of a scanline is determined based on the results of the micro-detection step. Known micro-detection methods can be used to accomplish these functions, such as the micro-detection methods described in U.S. Pat. No. 5,293,430. The entire content of U.S. Pat. No. 5,293,430 is hereby incorporated by reference.

Next, the image run sections of the scanlines are combined to form windows. This is done by looking for portions of the image that are “white.” Such areas are commonly called “gutters.” The gutters typically separate different portions of a page of images. For instance, a white gutter region would exist between a half toned image and text describing the image. A horizontal gutter might exist between different paragraphs of a page of text. Likewise, a vertical gutter might exist between two columns of text.

Statistics on the macro-detection results within each window are then compiled and examined. Based on the statistics, each window is classified, if possible, as a particular image type. At the end of the first pass, the beginning point of each window is recorded in memory. If a window appears to contain primarily a single type of image data, the image type is also recorded. If a window appears to contain more than one image type, the window is identified as a “mixed” window.

During a second pass through the image data, the micro-detection, macro-detection, and windowing steps are repeated. Those pixels within windows that were labeled as single image type during the first pass are simply labeled with the known image type. Those pixels that are within a window that was labeled as “mixed” during the first pass, are labeled based on the results of the micro-detection, macro-detection and windowing steps performed during the second pass. Once a pixel has been labeled as a particular image type, further processing of the image data may also occur during the second pass.

Because the same hardware is used to perform both the first and second passes, there is no additional cost for the second pass. In addition, because the image type classification of each pixel is not recorded at the end of the first pass, the memory requirements and thus the cost of an apparatus for performing the method are reduced.

A block diagram of a two pass segmentation and classification method embodying the invention is shown in FIG. 4. The method segments a page of image data into windows, classifies the image data within each window as a particular image type, and records information regarding the window and image type of each pixel. Once the image type for each window is known, further processing of the image data can be efficiently performed.

The image data comprises multiple scanlines of pixel image data, each scanline typically including intensity information for each pixel within the scanline. Typical image types include graphics, text, low-frequency halftone, high-frequency halftone, contone, etc.

During a first step S101, micro-detection is carried out. During micro-detection, multiple scanlines of image data are buffered into memory. Each pixel is examined and a preliminary determination is made as to the image type of the pixel. In addition, the intensity of each pixel is compared to the intensity of its surrounding neighboring pixels. A judgment is made as to whether the intensity of the pixel under examination is significantly different than the intensity of the surrounding pixels. When a pixel has a significantly different intensity than its neighboring pixels, the pixel is classified as an edge pixel.

During a second step S103, macro-detection is performed. During the macro-detection step, the results of the micro-detection step are used to identify those pixels within each scanline that are edges and those pixels that belong to image runs. The image type of each image run is then determined based on the micro-detection results. The image type of an image run may also be based on the image type and a confidence factor of an adjacent image run of a previous scanline. Also, if an image run of a previous scanline was impossible to classify as a standard image type, but information generated during examination of the present scanline makes it possible to determine the image type of the image run of the previous scanline, that determination is made and the image type of the image run of the previous scanline is recorded.

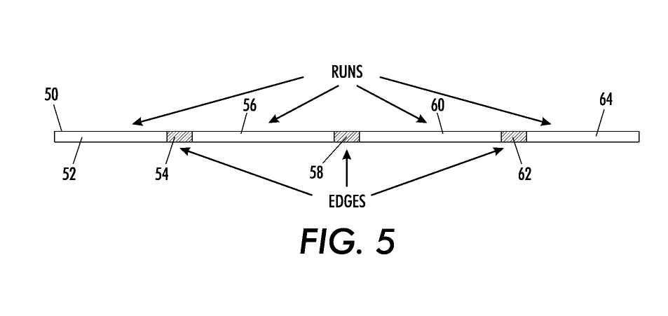

An example of a single scanline of image data is shown in FIG. 5. During the macro-detection step, adjacent pixels having significantly different intensities from each other are classified as edges 54, 58, and 62. Portions of the scanline between the edges are classified as image runs 52, 56, 60, and 64.

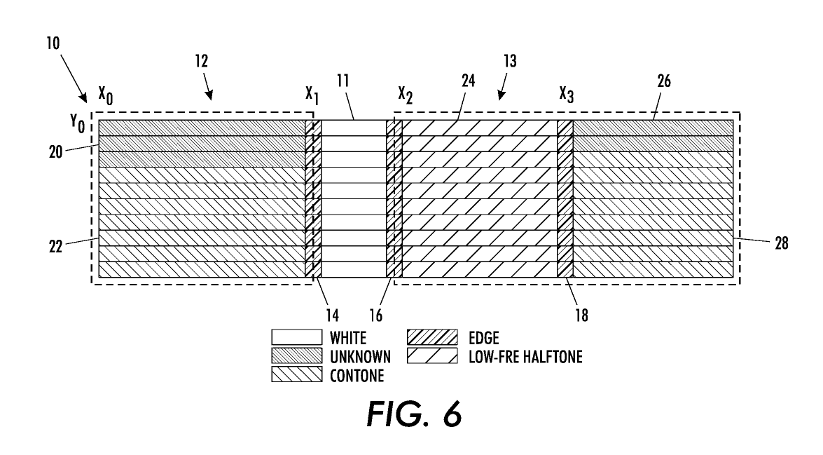

In the next step S105, the image runs of adjacent scanlines are combined to form windows. A graphical representation of multiple scanlines that have been grouped into windows is shown in FIG. 6. The image data has been separated into a first window 12 and a second window 13, separated by a gutter 11. A first edge 14 separates the first window 12 from the remainder of the image data. A second edge 16 separates the second window 13 from the remainder of the image data. In addition, a third edge 18 separates the second window 13 into first and second portions having different image types.

In the next step S107, statistics are gathered and calculated for each of the windows. The statistics are based on the intensity and macro-detection results for each of the pixels within a window.

In the next step S109, the statistics are examined in an attempt to classify each window. Windows that appear to contain primarily single type of image data are classified according to their dominant image types. Windows that contain more than one type of image are classified as “mixed.”

At the end of the first pass, in step S110, the beginning point and the image type of each of the windows is recorded.

During the second pass, in steps S111, S113, and S115, the micro-detection, macro-detection and window generation steps, respectively, are repeated. In the next step S117, labeling of the pixels occurs. During the labeling step, information about the image type and the window of each pixel is recorded. If a pixel is within a window that was classified as a particular image type during the first pass, each pixel within the window is labeled with the window's image type. If a pixel is within a window that was classified as “mixed” during the first pass, the micro-detection, macro-detection and windowing steps performed during the second pass are used to assign an image type to the pixel. At the end of the labeling step, each pixel is labeled as a particular image type.

Once each portion of the image data has been classified according to standard image types, further processing of the image data can be efficiently performed. Since the micro-detection and macro-detection results from the first pass are not recorded for each pixel of the image, the memory requirements for a device embodying the invention are minimized. This helps to minimize the cost of such an apparatus.

In the method according to the invention, a macro-detection step for examining a scanline of image data may include the steps of separating a scanline into edge portions and image runs and classifying each of the image runs based on statistics for the image data within each image run. The macro-detection step could also include clean up steps wherein each of the edge sections of the scanline are also classified based on (1) the image data of the edge sections and (2) the classification of surrounding image runs. The clean up steps might also include reclassifying image runs based on the classification of surrounding image runs.

A more detailed description of this process is set forth in U.S. Pat. No. 5,850,474 and U.S. Pat. No. 6,240,205. The entire contents of U.S. Pat. No. 5,850,474 and U.S. Pat. No. 6,240,205 are hereby incorporated by reference.

In the conventional process of reconstructing a contone image from a binary image, the binary image is filtered using a matrix of pixels centered on the pixel being reconstructed. The matrix is usually square, although it may be rectangular or other shape. The values in this matrix are chosen to provide a digital filtering function when the pixels of the image are convoluted with the filter matrix. Such processes are well known to those familiar with the art and will not be further described here. The equations governing this reconstruction are given by:

$${t}_{x} = {\sum }_{i} {\sum }_{j} {x}_{ij} * {f}_{ij}$$

where tₓ is the value of the output pixel, xᵢⱼ is the input binary pixel at location (i, j) relative to the pixel under test, fᵢⱼ are the filter weights, and the summation is over all the pixels in the filter window.

If such is a filter is applied, the resulting output is a contone reconstruction of the original image. If the binary representation is of high enough resolution, the contone image is a close reproduction of the original image and there will be few or no visible artifacts.

However the process of reconstruction will tend to soften edges. An edge is defined as a portion of the original image that has a rapid transition from high to low density or from low to high density. The softening problem may have the tendency of reducing the rapidity of such transitions. The visual effect of such edges is an apparent blur. This distortion is particularly objectionable in those areas of the original where text or line art is present. Text images depend on sharp edges at the edges of the characters to increase the ability of the reader to quickly distinguish different letter shapes.

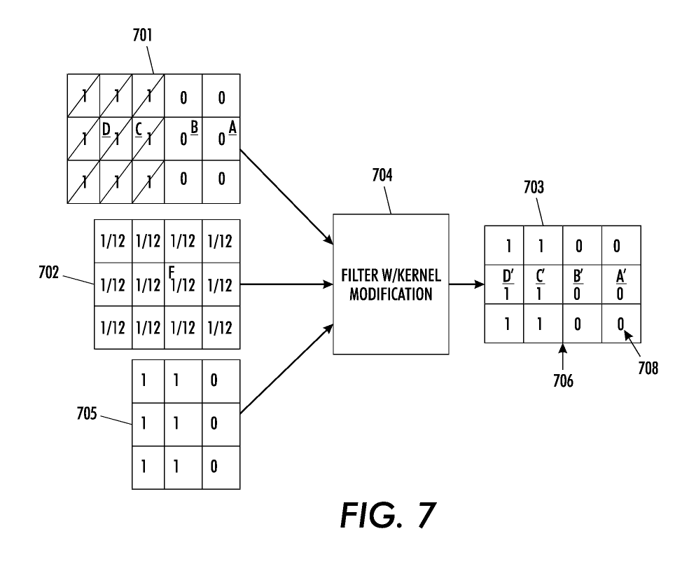

FIG. 7 shows an example of modifying the filtering process to exclude any pixels that are tagged as edges from the filtering process.

In FIG. 7, a portion of an image 701, in the form of a matrix, is shown. In the portion of the image 701, a vertical edge transitioning from black to white is shown, whereby a black region, represented by the numeric binary values “1” and slashed boxes, occupies the leftmost vertical column, and a white region, represented by the numeric binary values “0” and non-slashed boxes, occupies the center and rightmost vertical columns of the portion of the image 701. A filter kernel 702 provide a simple matrix of filter weights wherein an output pixel is the evenly weighted average of the nine pixels covered by the filter kernel 702. After a filter 704 performs the filtering operation, a portion of a output image 703 is generated.

The portion of the output image 703, as illustrated in FIG. 5, demonstrates that the original sharp edge of the portion of the image 701 has been converted to a sharp edge 706 with no ghost image artifact 708. More specifically, the original edge of the portion of the image 701 made the transition from “1” to “0” in a width of a single pixel. On the other hand, the filtered edge 706 of the portion of the output image 703 has a transition 706 from “1” to “0” being a width of a single pixel and no ghost artifact 708.

In other words, when the pixel A of the portion of the image 701 of FIG. 7 is processed by the filter 704, the output pixel A′ of the portion of the output image 703 has a value of “0” indicating, in this example, no ghost artifact 708, assuming that the column to the right of the rightmost illustrated column contained only “0” values. It is noted that the pixel of interest has a filter position that is associated with the highlighted pixel position F. The output value of output pixel A′ of the portion of the output image 703 has a value of “0” because the pixels associated with the column of the portion of the image 701 associated with the pixel C of the portion of the image 701 were tagged as being edge pixels. Due to the pixels being tagged as edge pixels, the values associated with the pixels are not included in the filtering process. The filtering process is utilized because the pixel in question, the pixel A of the portion of the image 701, is not tagged as an edge. But since the filtering process would normally process edge associated pixels, the particular edge pixel values are individually excluded from the filtering process.

Moreover, when the pixel B of the portion of the image 701 is processed by the filter 704, the output pixel B′ of the portion of the output image 703 has a value of “0” indicating, in this example, a white region because pixel B of the portion of the image 701 had been tagged as an edge, and thus, the filter value for the pixel B of the portion of the image 701 is not selected as the output value for output pixel B′ of the portion of the output image 703, but the actual value of pixel B of the portion of the image 701 is passed through as the output pixel B′ of the portion of the output image 703.

Furthermore, when the pixel C of the portion of the image 701 is processed by the filter 704, the output pixel C′ of the portion of the output image 703 has a value of “1” indicating, in this example, a black region because pixel C of the portion of the image 701 had been tagged as an edge, and thus, the filter value for the pixel C of the portion of the image 701 is not selected as the output value for output pixel C′ of the portion of the output image 703, but the actual value of pixel C of the portion of the image 701 is passed through as the output pixel C′ of the portion of the output image 703.

Lastly, when the two columns to the left of the leftmost illustrated column contain only “1” values and the center pixel D of the portion of the image 701 is processed by the filter 704, the resulting output pixel D′ of the portion of the output image 703 has a value of “1” indicating, in this example, a black region because pixel D of the portion of the image 701 had not been tagged as an edge, and thus, the filter value for the pixel D of the portion of the image 701 is selected as the output value for output pixel D′ of the portion of the output image 703.

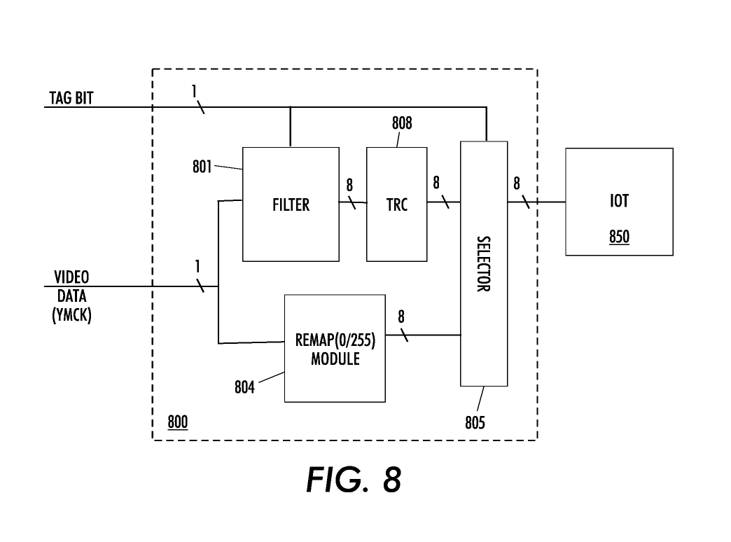

FIG. 8 shows a block diagram of a device to implement the process illustrated in FIG. 7 and described above. As illustrated in FIG. 8, image data is sent to two modules. The first module, a digital filter module 801 accepts the image and tag data and digitally filters the image data. The second module, a Remap “255/0” module 804, outputs either 255 (all 8 bits ON) or 0 (all 8 bits OFF) depending on whether the input pixel has a value of “1” or “0.” The output of these two modules is sent to a selector module 805. The output of the selector module 805, which is controlled by the tag data stream, is sent to an image output terminal (IOT) 850, which converts the image data to a hard copy of the image. If the tag bit is 1, the selector output is identical to the Remap “255/0” module 804, and if the tag bit is 0, the selector output is identical to the output of the digital filter module 801.

The digital filter module 801 includes an input from the tag data stream as well as the image stream. The filtering process of FIG. 8 requires that any edge pixel inside of the filter window is not included in the averaging process. By doing so, the edge pixels that are near the pixel under consideration are excluded from the averaging process. This essentially eliminates the edge artifacts from the reconstructed image.

The implementation of FIG. 8 can be described by the following logical equation:

$${t}_{x} = {\sum }_{i} {\sum }_{j} {x}_{ij} * {f}_{ij} * {w}_{ij}^{′}$$

Where the tₓ, xᵢⱼ, and fᵢⱼ are as before, but w′ᵢⱼ is a weight value determined by the tag matrix. If pixel ij in the tag matrix is 1, indicating that the pixel is an edge pixel, wᵢⱼ is zero and the corresponding pixel in the binary image is not included in the output summation. In a different embodiment, if pixel ij in the tag matrix is 1, indicating that the pixel is an edge pixel, wᵢⱼ is zero and the other weight coefficients may be modified to ensure that the remaining non-zero coefficients, when summed, equal a predetermined filter kernel matrix value. In a further embodiment, if pixel ij in the tag matrix is 1, indicating that the pixel is an edge pixel, wᵢⱼ is zero and the other weight coefficients may be modified to ensure that the remaining non-zero coefficients, when summed, equal a predetermined filter kernel matrix value of one. In these further embodiments, the coefficients or weights of the filter kernel associated with the remaining non-zero coefficients or weights are further modified to normalize the filter kernel matrix value.

As noted above, several additional features may be added to this system as alternatives. For example, the digital filter kernel is usually implemented so that the sum of the weights or coefficients in the filter matrix is normalized to 1. It is noted that the process may choose to re-normalize the filter matrix on the fly to take into account those weights or coefficients that are not used because the weights or coefficients coincide with tagged pixels.

FIG. 8 further shows a tonal reproduction curve circuit 808, which performs a tonal reproduction curve operation on the output of the digital filter 801. This tonal reproduction curve (“TRC”) circuit 808 performs a simple table lookup operation to transform the output of the digital filter 801 to a new set of values that are consistent with the filter operation. It may consist of a plurality of tables that are selected by a signal from the digital filter 801. The signal may be computed by the digital filter 801 as a function of the number of filter elements that are eliminated by ignoring tagged pixels. The signal may also be based on the number of eliminated pixels, or by a more complex computation that renormalizes the filter kernel based on the weights or coefficients of the pixels that are not counted.

The TRC circuit may also function as a normal TRC circuit in that the tonal reproduction curve may be based on factors that are independent of the filter operations. For example, the tonal reproduction curve could compensate for the response of the image output terminal or print engine. The tonal reproduction curve could be calculated based on the image content and a desire to normalize the tone response curve of the system. Finally, the tonal reproduction curve can also be altered in response to user input, for example, to change the contrast or lightness/darkness of the output image. Of course, any of these tonal reproduction curves can be concatenated with a tonal reproduction curve to compensate for the filtering operations to give a single tonal reproduction curve that accomplishes all of these goals.

As noted above, the tag bit can be used to determine whether to apply the filter or not, but the tag bit can also be used for each individual pixel location to determine whether to use that pixel in the sum of the filtered pixels. This has the effect of eliminating ghosting around text on the output image.

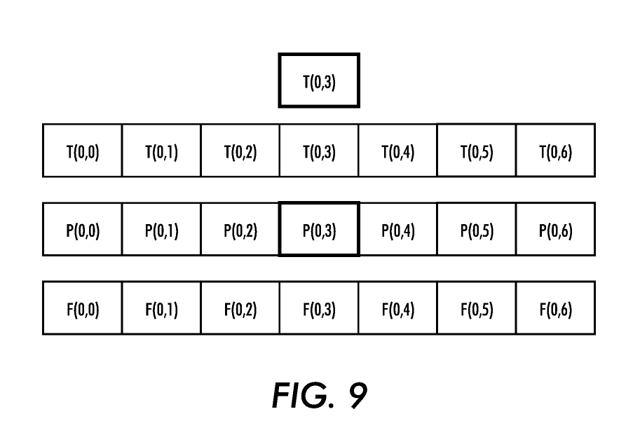

FIG. 9 provides another illustration of using the tag bit as part of the filtering operation to determine whether to include the individual pixels in the filtered total. Moreover, although the filtering process is typically a 2-dimensional process, FIG. 9 utilizes a 1-dimensional example for simplicity. In this example, the process is a binary data extended to contone process

As illustrated in FIG. 9, the binary data extended to contone process is a filtering process utilizing a standard convolution operation upon an input pixel value P(0,3) to realize an output pixel value P′(0,3). As noted above, with respect to the conventional process, if the pixel P(0,3) is not tagged, namely T(0,3) is equal to zero, the output pixel value for P′(0,3) is the summation of the products (Pᵢⱼ)(Fᵢⱼ). On the other hand, if the pixel P(0,3) is tagged, namely T(0,3) is equal to one, the output pixel value for P′(0,3) is equal to P(0,3).

With respect to a binary data extended to contone process that eliminates ghost artifacts, one embodiment, utilizing the illustration of FIG. 9, may operate as follows.

If the pixel P(0,3) is not tagged, namely T(0,3) is equal to zero, the output pixel value for P′(0,3) is the summation of the products (Pᵢⱼ)(Fᵢⱼ) wherein (Pᵢⱼ)(Fᵢⱼ) is only calculated when the value of T(i,j) equals zero. If the value of T(i,j) equals one, (Pᵢⱼ)(Fᵢⱼ) is either eliminated from the overall summation or set to a zero value. On the other hand, if the pixel P(0,3) is tagged, namely T(0,3) is equal to one, the output pixel value for P′(0,3) is equal to P(0,3).

With respect to a binary data extended to contone process that eliminates ghost artifacts, another embodiment, utilizing the illustration of FIG. 9, may operate as follows.

If the pixel P(0,3) is not tagged, namely T(0,3) is equal to zero, the output pixel value for P′(0,3) is the summation of the components of (Fᵢⱼ) when both the value of T(i,j) equals zero and the value of P(i,j) is equal to one. If the value of T(i,j) equals one or the value of P(i,j) is not equal to one, (Fᵢⱼ) is either eliminated from the overall summation or set to a zero value. On the other hand, if the pixel P(0,3) is tagged, namely T(0,3) is equal to one, the output pixel value for P′(0,3) is equal to P(0,3).

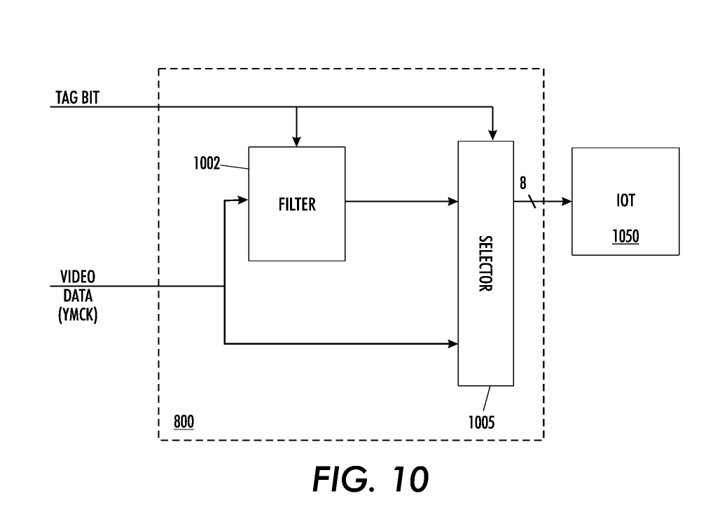

FIG. 10 illustrates a system for converting edge-tagged pixels of image data to pixels of contone image data. As illustrated in FIG. 10, a filter 1000 receives both image data and the tag bits. The filter kernel 1002 determines a tagged state value of each pixel of image data within a predefined neighborhood of pixels wherein each pixel of image data within the predefined neighborhood of pixels has an associated image value and a first pixel of image data within the predefined neighborhood of pixels is associated a first pixel of contone image data. The filter 1002 filters, using a predetermined set of filter weighting values wherein each pixel of image data within the predefined neighborhood of pixels has an associated filter weighting value, each image value of each pixel of image data within the predefined neighborhood of pixels having a tagged state value indicating that the pixel of image data is a non-edge pixel to generate a filtered image value for each pixel of image data within the predefined neighborhood of pixels having a tagged state value indicating that the pixel of image data is a non-edge pixel; assigns, a predetermined filtered image value to each pixel of image data within the predefined neighborhood of pixels having a tagged state value indicating that the pixel of image data is an edge pixel; and sums all filtered image values for the predefined neighborhood of pixels to produce an image data sum value.

Based on the tag value for the first pixel of image data within the predefined neighborhood of pixels, a selector 1005 either allows, when the tagged state value of the first pixel of image data indicates the first pixel of image data is a non-edge pixel, the image data sum value to be assigned as an image data value for the first pixel of contone image data or the image data value of the first pixel of image data to be assigned as an image data value for the first pixel of contone image data. It is noted that the predetermined filtered image value may be zero. This process can be utilized when each pixel of image data within the predefined neighborhood of pixels has an associated binary image value.

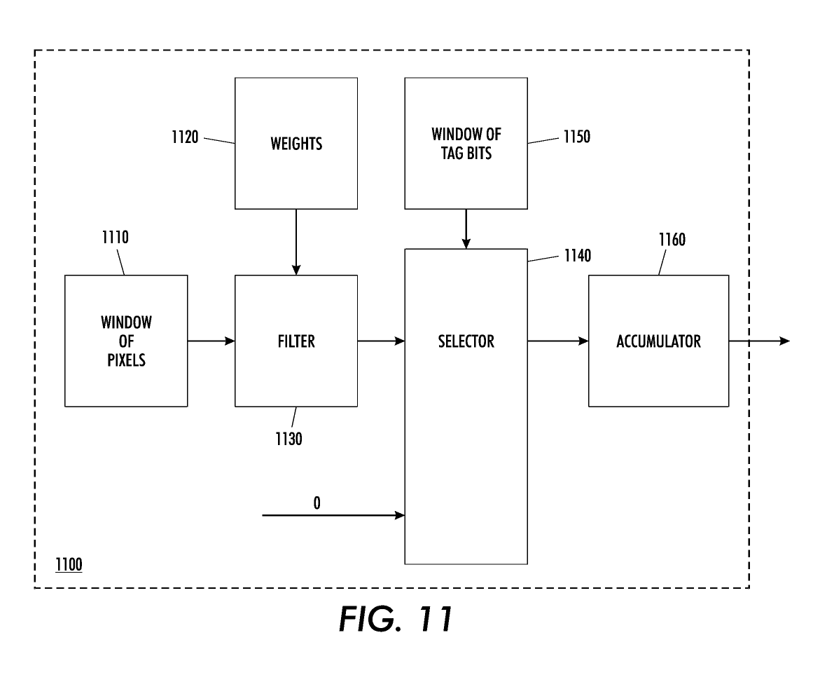

FIG. 11 illustrates a filter circuit configuration that enables the converting of edge-tagged pixels of image data to pixels of contone image data. As illustrated in FIG. 10, a filter 1100 includes a buffer 1110 for storing a window of pixels. This window of pixels may be a two-dimensional matrix of image data. The image data within the buffer 1110 is fed to a filter 1130. The filter 1130 also receives filter weights values from a filter weights buffer or memory 1120.

Upon receiving the image data and the filter weights, the filter 1130 multiplies each image data value with the associated filter weight value. The product is received by selector 1140. Selector 1140 selects between the product from filter 1130 and a zero value based upon tag bit data received from a tag bit buffer or memory 1150. More specifically, when the pixel associated with the product is tagged as a non-edge pixel, the selector 1140 selects the product from filter 1130. When the pixel associated with the product is tagged as an edge pixel, the selector 1140 selects the zero value. The selected value is received by accumulator 1160 which generates the non-edge image data value for the contone image.

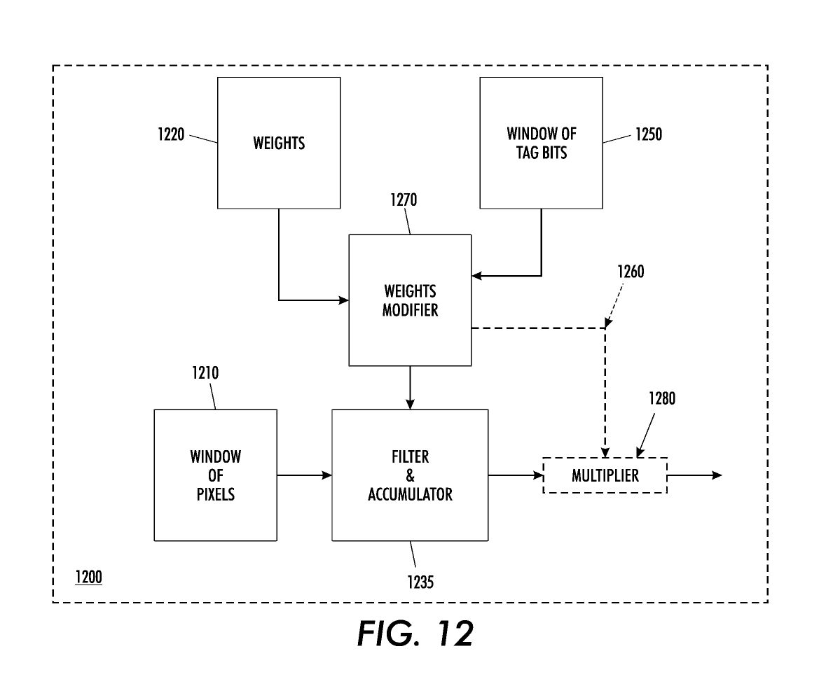

FIG. 12 illustrates another filter circuit configuration that enables the converting of edge-tagged pixels of image data to pixels of contone image data. As illustrated in FIG. 11, a filter 1200 includes a buffer 1210 for storing a window of pixels. This window of pixels may be a two-dimensional matrix of image data. The image data within the buffer 1210 is fed to a filter & accumulator 1235. The filter & accumulator 1235 also receives filter weights values from a filter weights modifier circuit 1270.

Upon receiving the image data and the filter weights, the filter & accumulator 1235 multiplies each image data value with the associated filter weight value. The product is the generated non-edge image data value for the contone image.

As further illustrated in FIG. 12, the filter weights modifier circuit 1270 receives filter weights values from a filter weights buffer or memory 1220 and tag bit data from a tag bit buffer or memory 1250. The filter weights modifier circuit 1270 utilizes this data, in a variety of ways to create a matrix of modified filter weight values to be utilized by the filter & accumulator 1235.

For example, the filter weights modifier circuit 1270 determines a tagged state value of each pixel of image data within a predefined neighborhood of pixels and a number, N, pixels of image data within the predefined neighborhood of pixels having a tagged state value indicating that the pixel of image data is a non-edge pixel. In this example, the filter weights modifier circuit 1270 modifies, when the tagged state value of the first pixel of image data indicates the first pixel of image data is a non-edge pixel, a predetermined set of filter weighting values wherein each pixel of image data within the predefined neighborhood of pixels has an associated filter weighting value, such that each filter weighting value associated with pixels of image data within the predefined neighborhood of pixels having a tagged state value indicating that the pixel of image data is a non-edge pixel is equal to 1/N and each filter weighting value associated with pixels of image data within the predefined neighborhood of pixels having a tagged state value indicating that the pixel of image data is an edge pixel is equal to 0.

The filter weights modifier circuit 1270 may also modify, when the tagged state value of the first pixel of image data indicates the first pixel of image data is an edge pixel, the predetermined set of filter weighting values such that the filter weighting value associated with the first pixel of image data is equal to 1 and each filter weighting value associated with a non-first pixel of image data within the predefined neighborhood of pixels is equal to 0.

In another example, the filter weights modifier circuit 1270 determines a tagged state value of each pixel of image data within a predefined neighborhood of pixels and a sum, S, of all filter weighting values within the predetermined set of filter weighting values associated with pixels of image data within the predefined neighborhood of pixels having a tagged state value indicating that the pixel of image data is a non-edge pixel. In this example, the filter weights modifier circuit 1270 modifies, when the tagged state value of the first pixel of image data indicates the first pixel of image data is a non-edge pixel, a predetermined set of filter weighting values wherein each pixel of image data within the predefined neighborhood of pixels has an associated filter weighting value, such that each filter weighting value associated with pixels of image data within the predefined neighborhood of pixels having a tagged state value indicating that the pixel of image data is a non-edge pixel is equal to a product of the predetermined filter weighting value and 1/S and each filter weighting value associated with pixels of image data within the predefined neighborhood of pixels having a tagged state value indicating that the pixel of image data is an edge pixel is equal to 0.

The filter weights modifier circuit 1270 may also modify, when the tagged state value of the first pixel of image data indicates the first pixel of image data is an edge pixel, the predetermined set of filter weighting values such that the filter weighting value associated with the first pixel of image data is equal to 1 and each filter weighting value associated with a non-first pixel of image data within the predefined neighborhood of pixels is equal to 0.

Another alternative for modifying the filter weights is to use the sum of the filter weights of either the excluded pixels, or of only the included pixels, and using this value as the entry into a lookup table whose output can be a factor by which to multiply the remaining, non-excluded filter, weights, the filter weights associated with pixels having a tag value indicating a non-edge. This can be applied internally to the filter weights in element 1270 of FIG. 12, or alternatively, the weight can be output, as signal 1260, from the weights modifier element 1270 and applied as an input to a multiplier element 1280 where it multiplies the output of the digital filter.

More specifically, filter weights modifier circuit 1270 may produce a sum of predetermined filter weights for pixels of image data within the predefined neighborhood of pixels having a tagged state value indicating that the pixel of image data is a non-edge pixel. The filter weights modifier circuit 1270 then may apply the sum as an input to a lookup table and use an output of the lookup table, corresponding to inputted sum, to modify the predetermined filter weights for pixels of image data within the predefined neighborhood of pixels having a tagged state value indicating that the pixel of image data is a non-edge pixel.

On the other hand, filter weights modifier circuit 1270 may produce a sum of predetermined filter weights for pixels of image data within the predefined neighborhood of pixels having a tagged state value indicating that the pixel of image data is an edge pixel. The filter weights modifier circuit 1270 then may apply the sum as an input to a lookup table and use an output of the lookup table, corresponding to inputted sum, to modify the predetermined filter weights for pixels of image data within the predefined neighborhood of pixels having a tagged state value indicating that the pixel of image data is a non-edge pixel.

Furthermore, filter weights modifier circuit 1270 may produce a sum of predetermined filter weights for pixels of image data within the predefined neighborhood of pixels having a tagged state value indicating that the pixel of image data is a non-edge pixel. The filter weights modifier circuit 1270 may apply the sum as an input to a lookup table, and a multiplier may be used to multiply the image data sum value by an output value from the lookup table, corresponding to inputted sum to modify the image data sum value.

Lastly, filter weights modifier circuit 1270 may produce a sum of predetermined filter weights for pixels of image data within the predefined neighborhood of pixels having a tagged state value indicating that the pixel of image data is an edge pixel. The filter weights modifier circuit 1270 may apply the sum as an input to a lookup table, and a multiplier may be used to multiply the image data sum value by an output value from the lookup table, corresponding to inputted sum to modify the image data sum value.

It will be appreciated that while the image reconstruction process has been illustrated in the context of a digital copying process, it will be recognized by those skilled in the art that there are other contexts in which this operation can also be applied. For example, in networked scanning application, where an image is scanned at one place and electronically transmitted elsewhere. This binary plus tag image format can allow for a more robust reconstruction process at the receiving end of the networked scanning operation. Moreover, the image reconstruction process can be realized in software, hardware, or a combination of both.

An alternate method that reconstructs a contone image from the binary image can be used that does not require edge tagging and yet still preserves edge acuity by using pattern recognition methods for the reconstruction.

To realize binary to contone conversion, the pattern of pixels in the neighborhood of the pixel being converted is examined. An example of a pattern identifier process is disclosed in U.S. Pat. No. 6,343,159. The entire content of U.S. Pat. No. 6,343,159 is hereby incorporated by reference.

Once the pattern is identified, a pattern identifier dataword is forwarded to a look-up table, wherein the look-up table is capable of converting the pattern identifier dataword to a contone value.

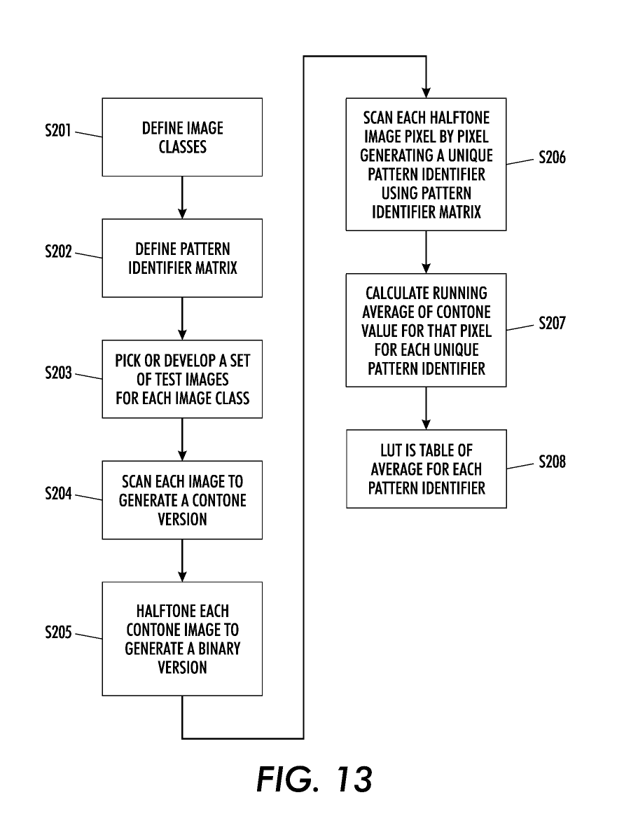

FIG. 13 shows a flowchart for creating the values for the look-up tables. At step S202, a pattern identification matrix is chosen. The pattern identification matrix is a small rectangular window around each pixel that is used to identify the pattern of pixels around the pixel of interest. In the following discussion, the height and width of the window are N and M, respectively.

For encoding, the size of the look-up table is 2^{N*M}; i.e., a 4×4 pattern identification matrix window generates a look-up table that is 65536 elements long. For each image, a pattern kernel is centered on the pixel of interest and a pattern identifier is generated. The process of generating the pattern identifier will be described in more detail below.

A large set of test documents is assembled at step S203. The test document set may be composed of portions of actual customer images and synthetically generated images that are representative of the image content likely to be encountered. The document class representing text and line art set would include a large variety of text in terms of fonts and sizes as well as non-Western character sets e.g. Japanese and Chinese.

In the next phase of the calibration process, at step S204, each of these test documents is scanned using a scanner. The output of this scan is the contone version of the document. This contone image is now further processed, at step S205, with a halftone. The result of the process of step S205 is a binary version of the same document image. Therefore, when completed, the calibration process generates two images per document: a contone image and a binary image.

Each halftone image is scanned, pixel by pixel, at step S206, and for each pixel, a pattern identifier is generated. The same process of generation is used during calibration and reconstruction. Each element of the pattern kernel is identified with a power of 2 starting with 2⁰=1 and going to 2^{(N*M-1)}. There is no unique way of matching each element of the kernel with a power of 2; the pattern can be chosen at random; as long as the same matching is used for the calibration and reconstruction. However, it is easier to have some simple ordering of the matching, say from upper left to lower right going across the rows.

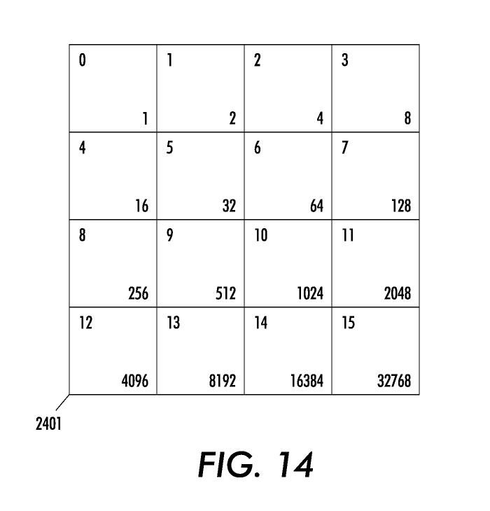

FIG. 14 shows an example of a matching scheme for a 4×4 kernel 2401. In each element of the kernel, the upper left hand number is a simple index into that element, while the lower right number is the power of 2 associated with the element. In this example, the weight of element of index i is given by Wᵢ=2ⁱ.

The pattern kernel is applied to each pixel in the binary image and a pattern identifier is generated by developing a N*M bit binary number where the 1s and 0s of the binary number are determined by the image pixel underlying the corresponding pattern kernel element. For those elements of the kernel where the corresponding pixel in the binary image is a 1, a 1 is entered into the corresponding power of 2 in the binary representation of the pattern identifier, and where the pixel is 0, a 0 is entered into the identifier. That is the pattern identifier is generated according to the equation:

Identifier=Σwᵢ*pᵢ

Where wᵢ is the weight for the pattern kernel element, and pᵢ is the corresponding image pixel value (0 or 1).

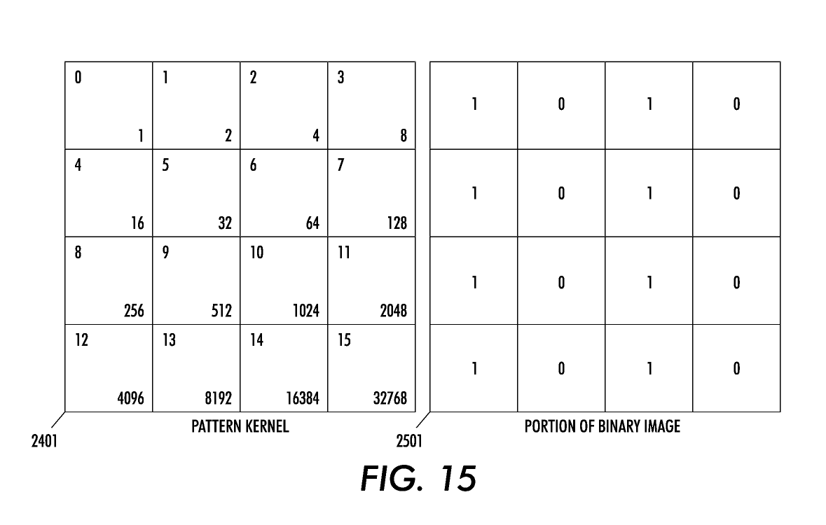

FIG. 15 shows an example for a part of an image with the 4×4 kernel applied. Using the pattern kernel 2401 and the image portion 2501, the pattern identifier for this pattern is given by the binary number: 0101101001011010 or decimal 23130.

Using the pattern identifier, the value of the pixel in the contone image that corresponds to the pixel in the center of the pattern kernel is selected. Using this value, the calibration program keeps a running average value of the contone value for all the pixels with the same pattern identifier, at step S207. As noted above, for a 4×4 window, there are potentially 65536 different pattern identifiers.

The process continues for all images in this way, a table of the average value of the contone pixels for each unique pattern identifier has been created. This average value will be the entry in the look-up table for the reconstruction process. The look-up table is simply a 65536 byte table whose entries are the average contone pixel value for each pattern identifier, at step S209.

As discussed above, each image pixel is input to the binary to contone reconstruction element of the image path along with its corresponding tag bits. The binary to contone element keeps a memory of a few scanlines and uses the scanlines to reconstruct, for each pixel, the pattern identifier using the same process as was used in the above-described calibration process. This pattern identifier is the address for the look-up tables, and the tag bits are used to choose which look-up table is actually used for generating the output. FIG. 6 shows schematically a system that carries out the binary to contone reconstruction.

In FIG. 6, the binary image data stream is input to a pattern identifier circuit 2601 that computes the pattern identifier, using the pattern kernel 2602. The pattern kernel is the same kernel that was used to generate the lookup tables. The output of the pattern identifier circuit 2601 is a N*M bit number that is input to the look-up table 2603. This N*M bit number is the pattern identifier for the pixel under evaluation

The lookup table is the table generated during the calibration process shown in FIG. 13, and so the output is the contone value that was found to best represent this particular pattern identifier during the calibration process. The look-up table can be implemented as a simple memory chip or equivalent circuit elements, or the look-up tables may be part of a larger ASIC or similar complex programmable device. The look-up tables may be hard coded, permanently programmed for example as ROM memory, or the look-up tables may be programmable to allow for changes.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A method for processing an image in a digital reprographic system, comprising:
(a) performing a first segmentation process upon a contone digital image to identify one of a plurality of image data types for each pixel in the contone digital image;
(b) generating tags, the tags coding the identity of the image data type of each pixel of the contone digital image;
(c) binarizing the contone digital image;
(d) reconstructing the binarized digital image to generate a reconstructed contone digital image; and
(e) performing a second segmentation process upon the reconstructed contone digital image to identify areas of the reconstructed contone digital image with common image data types.

2. The method as claimed in claim 1, further comprising:
(f) processing the reconstructed contone digital image based upon the tags.

3. The method as claimed in claim 1, wherein the plurality of image data types includes text and line art.

4. The method as claimed in claim 1, wherein the plurality of image data types includes contone images.

5. The method as claimed in claim 1, wherein the plurality of image data types includes halftones.

6. The method as claimed in claim 1, wherein the binarization of the contone image utilizes a halftone matrix.

7. The method as claimed in claim 1, wherein the binarization of the contone image utilizes error diffusion.

8. The method as claimed in claim 1, further comprising:
(f) converting a color contone digital image to a YCC color space before segmenting the color contone digital image.

9. The method as claimed in claim 1, further comprising:
(f) converting a color contone digital image to a L*a*b* color space before segmenting the color contone digital image.

10. The method as claimed in claim 1, wherein reconstruction of the binarized image maintains sharpness of edges based on the tag data stream.

11. The method as claimed in claim 1, wherein reconstruction of the binarized image utilizes a pattern identifier which is based on the pattern of pixels in a neighborhood around each pixel to choose one of a plurality of contone values.

12. A system for image processing in a reprographic system comprising:
a source of contone digital images;
a first segmentation module, operatively connected to said source of digital page images, to generate tags, the tags encoding the identity of the image data type of each pixel of the contone digital image;
a binary encoding module, operatively connected to said first segmentation module, said binary encoding module transforming the contone digital image into a high resolution binary image;
a decoding module, operatively connected to said binary encoding module, to convert the high resolution binary image into a second contone image; and
a second segmentation module to identify areas of the second contone image with common image data types.

13. The system as claimed claim 12, further comprising an image processing module, operatively connected to said second segmentation module, to image process the second contone image based upon the tags.

14. The system as claimed claim 12, wherein said binary encoding module utilizes a halftone matrix.

15. The system as claimed claim 12, wherein said binary encoding module utilizes error diffusion.

16. The system as claimed claim 12, wherein the plurality of image data types includes text and line art.

17. The system as claimed claim 12, wherein the plurality of image data types includes contone images.

18. The system as claimed claim 12, wherein the plurality of image data types includes halftones.

19. The system as claimed in claim 12, wherein the decoding module includes a two dimensional digital filter to reconstruct the second contone image.

20. The system as claimed in claim 12, wherein the decoding module includes a pattern generator to generate a pattern identifier which is used to choose one of a plurality of contone values.
